(19) United States
(12) Patent Application Publication
(10) Pub. No.: US 2026/0199917 A1
(43) Pub. Date: Jul. 16, 2026

(54) HIGH RELIABILITY SHEATHED AEROSOL FLOW SPLITTER

(71) Applicant: Optomec, Inc., Albuquerque, NM (US)

(72) Inventors: John David Hamre, Plymouth, MN (US); Chad Michael Conroy, Minneapolis, MN (US); John S. Wright, Edina, MN (US)

(73) Assignee: Optomec, Inc., Albuquerque, NM (US)

(21) Appl. No.: 19/133,219

(22) PCT Filed: Nov. 29, 2023
(86) PCT No.: PCT/US2023/081610

§ 371 Date: May 27, 2025

Related U.S. Application Data
(60) Provisional application No. 63/428,700, filed on Nov. 29, 2022.

(51) Int. Cl. B05B 7/12; B05B 7/08; B05B 7/14; B05B 12/18

(52) U.S. Cl. CPC B05B 7/12; B05B 7/0884; B05B 7/1486; B05B 12/18

(57) ABSTRACT

Method and apparatus for splitting an aerosol flow into multiple streams prior to deposition. The aerosol flow is surrounded in each outlet by a sheath gas flow. Adjusting the sheath gas flow in each outlet determines the amount, if any, of aerosol transported through each of the outlets. For example, the sheath flow in an outlet may be increased until all of the aerosol flow through that outlet is diverted to one or more other outlets. One of the outlets can be an exhaust outlet, which can exhaust all of the aerosol produced by the system if the aerosol flows in the other outlets are stopped, thus preventing material settling and, in combination with increasing the sheath gas flows in the other outlets, enables fast shuttering rates. The sheath gas prevents the aerosolized material from building up on the bottom of the splitter chamber and inside the outlets.

### CROSS-REFERENCE TO RELATED APPLICATIONS

This application claims priority to and the benefit of the filing of U.S. Provisional Patent Application No. 63/428,700 , entitled “HIGH RELIABILITY SHEATHED AEROSOL FLOW SPLITTER”, filed on Nov. 29, 2022, the entirety of which is incorporated herein by reference.

### BACKGROUND OF THE INVENTION

### Field of the Invention (Technical Field)

The present invention is related to apparatuses and methods for propagating an aerosol stream and separating the aerosol stream into separate discrete flows. The aerosol stream can be a droplet stream, a solid particle stream, or a stream comprising droplets and solid particles or droplets that contain solid particles.

### Background Art

Note that the following discussion may refer to a number of publications and references. Discussion of such publications herein is given for more complete background of the scientific principles and is not to be construed as an admission that such publications are prior art for patentability determination purposes.

Typical methods for splitting aerosol flows in aerosol jet printing equipment mimic that of pneumatic flow splitting and are accomplished with standard tubing connections such as tee shaped fittings and manifolds. Aerosol particles generally follow pneumatic flow lines resulting in aerosol transport; however, loss of aerosol along the transport path due to gravitational settling and particle impaction may occur, depending on flow velocity. Material accumulation caused by transport loss often degrades transport efficiency over as little as 4-8 hours and results in reduced system performance, yield and system run time.

Multiple nozzle aerosol jet applications where multiple identical features are printed simultaneously to increase system throughput require flow splitting if one aerosol generation source is used to supply all deposition nozzles. Balance of the aerosol flow across the aerosol streams created by the split determines how well the features match each other. Imbalance in aerosol flow results in reduced print quality as features deviate from one another in size or shape. Special chambers with one aerosol input and multiple outputs optimized to perform the task of splitting the aerosol may achieve <20% match across outputs and are aerosol particle diameter-and flow-dependent. These chambers suffer from gravitational settling losses and reliability challenges similar to tees and standard manifolds. There exists a need for flow splitting that is balanced across output flow channels with performance that supports run times greater than 8 hours.

In legacy aerosol jet printing systems, material to be printed is delivered to the print nozzle via a carrier gas that is introduced into the atomizer, which mixes with the droplets or particles produced by the atomizer to form an aerosol, which is transported to the deposition nozzle where a sheath flow is added to enable printing. The amount of material to be printed is directly controlled and proportional to the carrier gas flow. In order to decrease the mass flow the carrier gas flow must also decrease. When the carrier gas flow is low, the aerosol droplets and/or particles settle out of the flow, leading to a decrease or even a complete loss of mass output. Furthermore, in many systems, a pneumatic shutter is interposed between the atomizer and the print nozzle to turn the aerosol flow on and off, starting and terminating various printed features. In this configuration the speed at which the shutter can be operated depends directly on the carrier gas flow rate. If the carrier gas flow rate is very small, more time is required to clear out or fill up pneumatic shutter internal cavities, resulting in slower shuttering on and off times and less precision in printed feature detail.

### SUMMARY OF THE INVENTION (DISCLOSURE OF THE INVENTION)

An embodiment of the present invention is a method of depositing material, the method comprising atomizing the material to form an aerosol; transporting the aerosol into a chamber, the chamber comprising a plurality of outlets, each outlet providing a resistance to an aerosol flow; varying the resistance to the aerosol flow of each outlet, thereby directing the aerosol flow into one or more of the outlets at a predetermined amount of aerosol flow for each outlet; and depositing the material. The resistance to the aerosol flow of each outlet preferably comprises surrounding the aerosol flow in each outlet with a sheath gas and setting a flow of sheath gas in each outlet to achieve the predetermined amount of aerosol flow in each outlet. Increasing the flow of the sheath gas in an outlet preferably decreases the aerosol flow in the outlet, which preferably results in an increase of the aerosol flow in one or more other outlets. The flow of the sheath gas in the outlet may optionally be increased sufficiently to stop the aerosol flow in the outlet. Decreasing the flow of the sheath gas in an outlet preferably increases the aerosol flow in the outlet. The sum of all sheath gas flows and all aerosol flows exiting all of the outlets is preferably approximately constant regardless of the aerosol flow in any individual outlet. The method preferably comprises measuring the aerosol flow in each outlet and controlling the flow of the sheath gas in each outlet, preferably using a mass flow controller, to achieve the predetermined amount of aerosol flow in each outlet. Setting a flow of the sheath gas in each outlet is performed so that a sum of the flow of sheath gas and the aerosol flow in each outlet is approximately constant regardless of the amount of aerosol flow in the outlet. One of the outlets preferably comprises an exhaust outlet, in which case the method comprises exhausting aerosol through the exhaust outlet. A sum of the aerosol flows in all of the outlets is preferably constant regardless of the amount of aerosol flow in any individual outlet. The flow of sheath gas in all of the outlets except the exhaust outlet may optionally be increased sufficiently so that all of the aerosol entering the chamber is exhausted through the exhaust outlet, preferably substantially without a reduction in a velocity of the aerosol flow. The method preferably further comprises shuttering the aerosol flow and flow of sheath gas in at least one of the outlets. The sheath gas is preferably introduced into the chamber and proceeds along the bottom surface of the chamber prior to entering each of the outlets. The sheath gas preferably prevents buildup of the material on inner walls of the outlets and on the bottom surface of the chamber. At least one of the outlets preferably comprises a mist tube.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate the practice of embodiments of the present invention and, together with the description, serve to explain the principles of the invention. The drawings are only for the purpose of illustrating certain embodiments of the invention and are not to be construed as limiting the invention. In the drawings:

FIG. 1 is a schematic of an embodiment of an aerosol jet print engine aerosol transport path showing flows and aerosol distribution split into three streams.

FIG. 2 is an expanded view schematic of single mist tube assembly 2 of FIG. 1 showing the flows and aerosol distribution within a split aerosol stream.

FIG. 3 is a schematic of an embodiment of an aerosol jet print engine aerosol transport path with uneven flows and uneven aerosol distributions.

FIG. 4 is a schematic of the flows and aerosol distribution when all of the aerosol streams are directed out of one split.

FIG. 5 is a schematic of the flows and aerosol distribution when the aerosol streams are split between a nozzle and an exhaust valve.

### DETAILED DESCRIPTION OF EMBODIMENTS OF THE INVENTION

The present invention relates to an apparatus and method for splitting and adjusting aerosol flow in an aerosol deposition system. As used throughout the specification and claims, the terms “aerosol” or “mist” mean liquid droplets (which may optionally contain solid material in suspension), fine solid particles, or mixtures thereof, which are transported by a carrier gas.

In one or more embodiments of the present invention an aerosol delivery path is incorporated into an apparatus which transports material from an aerosol source, such as an ultrasonic or pneumatic atomizer, to a deposition nozzle. Prior to entering the deposition nozzle, a concentric sheath of gas is applied to surround the aerosol stream. As the combined stream flows through the nozzle, focusing of the aerosol occurs, resulting in deposition of printed features as small as 10 μm in width.

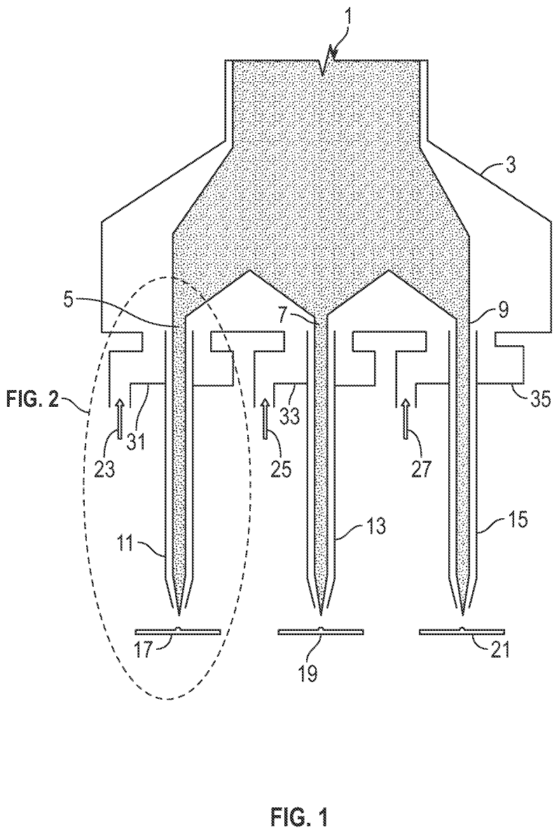

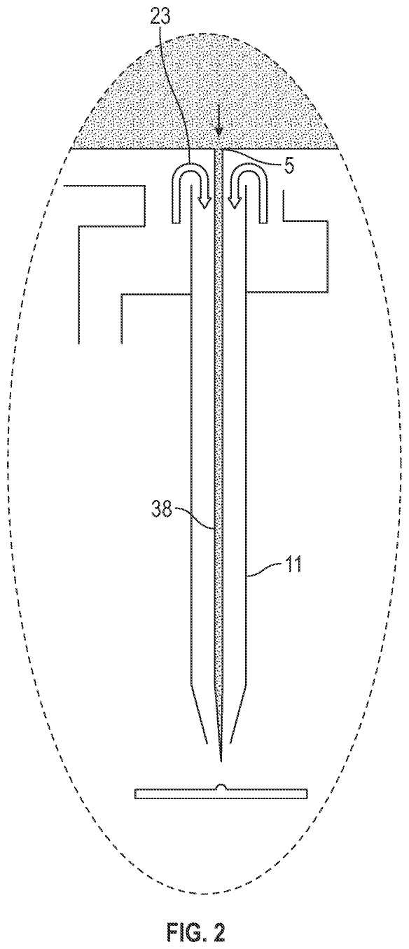

An embodiment of the present invention is a method for equally splitting aerosol flow among the nozzles, illustrated in FIG. 1. Aerosol flow 1 enters at the top of flow splitting chamber 3 and is split into three split outputs 5, 7, 9 flowing towards mist tubes 11, 13, 15 respectively. Simultaneously, sheath gases 23, 25, 27 enter sheath gas plenums 31, 33, 35 and are preferably circumferentially injected into flow splitting chamber 3 around the outside diameter of each mist tube 11, 13, 15. The sheath gases preferably focus the aerosol streams emerging from the deposition nozzle tip, resulting in deposition of printed features 17, 19, 21. Although three split outputs are shown, there can be any number of flow outputs. A detail of the flows in a single sheath gas plenum and mist tube is shown in FIG. 2. Sheath gas 23 preferably circumferentially surrounds the aerosol stream 38 flow through the mist tube 11, preferably substantially eliminating build up on the mist tube walls of the aerosolized material such as ink.

The mist tubes preferably act as flow restrictors to restrict the flow of the aerosol, providing resistance that can be utilized for creating controlled, varied aerosol flows in the various outlets. Varying the amount of the sheath flows works in combination with fixed flow resistances to cause the mist to choose one path or another. A flow restriction which provides a resistance to the aerosol flow, for example a nozzle, mist tube, orifice, or passage, is preferably located at each of the outlets of flow splitting chamber 3. In embodiments of the present invention, the amount of flow in each mist tube (or other flow restriction) is preferably determined by the sheath flow in each mist tube, which preferably displaces the corresponding aerosol flow in that mist tube. Therefore, by varying the amount of sheath flow in each mist tube the user can determine the relative aerosol flows in the mist tubes, including but not limited to splitting the flows and redirecting the aerosol flow from one or more outlets to one or more other outlets as desired.

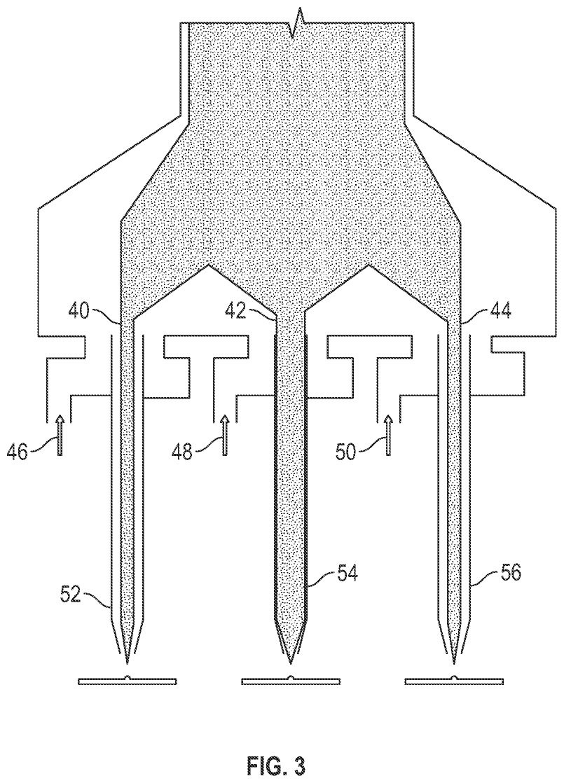

The flow rate of the output aerosol flow through a mist tube is preferably inversely related to the flow rate of the sheath gas in that tube. For example, in FIG. 3, the flow rate of each split output is unequal; the flow of sheath gas 46 in mist tube 52 is higher than the flow of sheath gas 50 in mist tube 56, which is higher than the flow of sheath gas 48 in mist tube 54, meaning that the output flow 40 is less than output flow 44, which is less than output flow 42. Thus the sheath flow in a mist tube can act as a flow restrictor in addition to the resistance to flow of the mist tube itself, restricting the flow of aerosol in that mist tube. The sheath flow may be increased in one or more of the mist tubes so that the flow of aerosol in each of those tubes is stopped. The flow rate of each sheath flow is preferably set by a mass flow controller. The method further optionally comprises, subsequent to splitting the aerosol flow, measuring the aerosol flow of each split output and adjusting the sheath flows to achieve balance or target output values for each output.

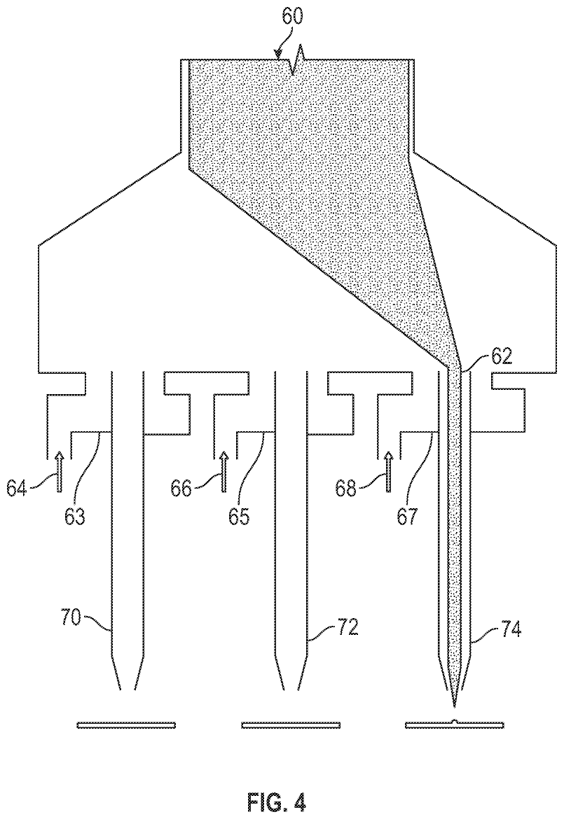

In yet another embodiment of the present invention, the aerosol stream is stopped in all flow outputs except one, illustrated in FIG. 4. Aerosol stream 60 is directed towards one split output 62 preferably by increasing sheath flows 64, 66 in corresponding sheath gas plenums 63, 65 so that the aerosol flow is cut off in corresponding mist tubes 70, 72. The sum of all of the flows into and out of the flow splitter preferably remains substantially constant. As sheath flows 64, 66 are increased in their respective sheath gas plenums 63 and 65, sheath flow 68 in corresponding sheath gas plenum 67 is preferably reduced by an amount equal to the sum of the increase in sheath gas flow 64 and the increase in sheath gas flow 66. Increasing sheath gas flows 64, 66 displaces the aerosol flow that otherwise would enter mist tubes 70, 72, so that the output aerosol flows only in mist tube 74.

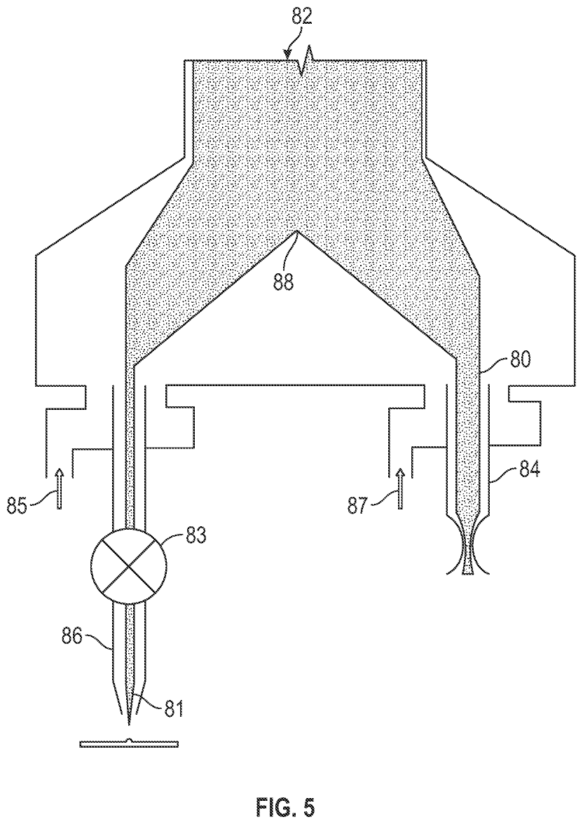

In another embodiment of the present invention, the aerosol stream is split between mist tube 86 and an exhaust outlet 84, as shown in FIG. 5. Exhaust flow 80 preferably enables the aerosol flow rate as aerosol 82 travels from the atomizer to location 88 where the aerosol flow splits to be kept high even when output aerosol flow 81 is low or stopped by diverting the excess aerosol out of the system through exhaust outlet 84 as exhaust flow 80. This minimizes the mass output loss due to gravitational settling (which occurs when the flow rate is low). This diversion is preferably accomplished by varying sheath gas flow 85 and exhaust outlet sheath gas flow 87 relative to one another. For example, sheath gas flow 85 may optionally be increased sufficiently to deflect all aerosol from mist tube 86, and decreasing exhaust outlet sheath gas flow 87 by a substantially equal amount preferably extracts the additional deflected aerosol through exhaust outlet 84.

The flow split can be utilized in combination with a shutter 83, preferably comprising a pneumatic shutter. As described above, a relatively high constant flow through shutter 83 is preferable to maintain rapid switching times of shutter 83, defined as less than about 20 ms. Because the total gas flow through shutter 83 is a combination of sheath gas flow 85 and output aerosol flow 81, when it is desirable to reduce output aerosol flow 81, some or all of output aerosol flow 81 is diverted to exhaust outlet 84. Sheath gas flow 85 is preferably increased to maintain a constant, relatively high total flow through shutter 83, enabling rapid shutter switching time. This also enables the aerosol flow in the system to remain constant and relatively high even though output aerosol flow 81 is low (or stopped), thus preventing mass settling as described above. In this way, the total combined flow out of mist tube 86 and exhaust outlet 84 preferably remains constant, while output aerosol flow 81 passing through shutter 83 can preferably be varied from 0-100%. Thus the amount of the aerosol traveling to the print nozzle (i.e. mist tube 86) is preferably modulated independently of the aerosol flow in the system, and the amount of gas flowing through shutter 83 can be kept at a high rate independent of the amount of aerosol material.

Note that in the specification and claims, “about” or “approximately” means within twenty percent (20%) of the numerical amount cited. As used herein, the singular forms “a,” “an,” and “the” include plural referents unless the context clearly dictates otherwise. Thus, for example, reference to “a functional group” refers to one or more functional groups, and reference to “the method” includes reference to equivalent steps and methods that would be understood and appreciated by those skilled in the art, and so forth.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A method of depositing material, the method comprising:
atomizing the material to form an aerosol;
transporting the aerosol into a chamber, the chamber comprising a plurality of outlets, each outlet providing a resistance to an aerosol flow;
varying the resistance to the aerosol flow of each outlet, thereby directing the aerosol flow into one or more of the outlets at a predetermined amount of aerosol flow for each outlet; and
depositing the material.

2. The method of claim 1 wherein the resistance to the aerosol flow of each outlet comprises surrounding the aerosol flow in each outlet with a sheath gas and setting a flow of sheath gas in each outlet to achieve the predetermined amount of aerosol flow in each outlet.

3. The method of claim 2 wherein increasing the flow of the sheath gas in an outlet decreases the aerosol flow in the outlet.

4. The method of claim 3 wherein decreasing the aerosol flow in the outlet results in an increase of the aerosol flow in one or more other outlets.

5. The method of claim 3 comprising increasing the flow of the sheath gas in the outlet sufficiently to stop the aerosol flow in the outlet.

6. The method of claim 2 wherein decreasing the flow of the sheath gas in an outlet increases the aerosol flow in the outlet.

7. The method of claim 2 wherein a sum of all sheath gas flows and all aerosol flows exiting all of the outlets is approximately constant regardless of the aerosol flow in any individual outlet.

8. The method of claim 2 comprising measuring the aerosol flow in each outlet and controlling the flow of the sheath gas in each outlet to achieve the predetermined amount of aerosol flow in each outlet.

9. The method of claim 8 wherein controlling the flow of the sheath gas is performed using a mass flow controller.

10. The method of claim 2 wherein setting a flow of the sheath gas in each outlet is performed so that a sum of the flow of sheath gas and the aerosol flow in each outlet is approximately constant regardless of the amount of aerosol flow in the outlet.

11. The method of claim 10 wherein one of the outlets comprises an exhaust outlet and the method comprises exhausting aerosol through the exhaust outlet.

12. The method of claim 11 wherein a sum of the aerosol flows in all of the outlets is constant regardless of the amount of aerosol flow in any individual outlet.

13. The method of claim 12 comprising increasing the flow of sheath gas in all of the outlets except the exhaust outlet sufficiently so that all of the aerosol entering the chamber is exhausted through the exhaust outlet.

14. The method of claim 13 performed substantially without a reduction in a velocity of the aerosol flow.

15. The method of claim 11 further comprising shuttering the aerosol flow and flow of sheath gas in at least one of the outlets.

16. The method of claim 2 wherein the sheath gas is introduced into the chamber and proceeds along a bottom surface of the chamber prior to entering each of the outlets.

17. The method of claim 16 wherein the sheath gas prevents buildup of the material on inner walls of the outlets and on the bottom surface of the chamber.

18. The method of claim 1 wherein at least one of the outlets comprises a mist tube.
